(19) United States
(12) Patent Application Publication
(10) Pub. No.: US 2009/0285419 A1
(43) Pub. Date: Nov. 19, 2009

(54) MICROELECTROMECHANICAL SYSTEM MICROPHONE

(75) Inventors: Hui-Shen Shih, Changhua Hsien (TW); Chung-Chih Chen, Taipei City (TW)

Correspondence Address: J C PATENTS, 4 VENTURE, SUITE 250, IRVINE, CA, 92618, US

(73) Assignee: UNITED MICROELECTRONICS CORP., Hsinchu (TW)

(21) Appl. No.: 12/119,703

(22) Filed: May 13, 2008

(51) Int. Cl. H04R 19/04

(52) U.S. Cl. 381/174

(57) ABSTRACT

A microelectromechanical system microphone is provided. The microelectromechanical system microphone includes a first electrode, a second electrode and a first dielectric layer. The first electrode is disposed on a substrate and has a first flexible portion. The second electrode is disposed between the first electrode. A material of the second electrode includes polysilicon or polycide. The first dielectric layer is at least partially disposed between the first and second electrodes so as to suspend the first flexible portion.

### BACKGROUND OF THE INVENTION

1. Field of the Invention

The present invention is directed to a microelectromechanical system microphone (MEMS microphone), and more particularly to an MEMS microphone capable of simplifying manufacturing process and having electrodes with features of good extension capability, low resistance, high sensitivity and etching-resistant capability.

2. Description of Related Art

With continuously improving technology, nowadays, various mircroelectromechnical system devices can be manufactured by micro-manufacturing technology. For example, these mircroelectromechnical system devices include motors, pumps, valves, switches, sensors, pixels, microphones and so on.

The microphones manufactured by adopting mircroelectromechnical system technology has advantages, such as light weight, small size and good signal quality, and hence, mircroelectromechnical system microphones have become the mainstream of miniaturized microphones. Furthermore, due to higher demands for mobile phones, improving quality of mobile phones and gradually matured technology of hearing aids, the demands for high-quality miniaturized microphones are rapidly increased.

### SUMMARY OF THE INVENTION

The present invention is directed to a microelectromechanical system microphone (MEMS microphone) capable of integrating a manufacturing process of MEMS microphone and a manufacturing process of complementary metal-oxide semiconductor (CMOS) or non-volatile memory so as to simplify manufacturing steps.

The present invention is further directed to an MEMS microphone having electrodes with features of good extension capability, low resistance, high sensitivity and etching-resistant capability.

The present invention provides an MEMS microphone, having a first electrode, a second electrode and a first dielectric layer. The first electrode is disposed on a substrate. The first electrode has a first flexible portion. The second electrode is disposed between the first electrode and the substrate. A material of the second electrode includes polysilicon or polycide. The first dielectric layer is partially disposed between the first electrode and the second electrode so as to suspend the first flexible portion.

According to an embodiment of the MEMS microphone of the present invention, a material of the first electrode is, for example, polysilicon, polycide, metal or alloy.

According to an embodiment of the MEMS microphone of the present invention, the first electrode is, for example, a multi-layer structure, and a material of the multi-layer structure includes polysilicon/polycide (X/Y represents a multi-layer consisted of X and Y), aluminum/copper, titanium/aluminum, titanium nitride/titanium/aluminum-copper alloy/titanium nitride/titanium, titanium nitride/aluminum-copper alloy/titanium nitride, titanium nitride/titanium/titanium nitride or titanium nitride/titanium.

According to an embodiment of the MEMS microphone of the present invention, the first flexible portion is, for example, in a net or bar shape.

According to an embodiment of the MEMS microphone of the present invention, the second electrode has a second flexible portion, and the first flexible portion at least partially overlaps the second flexible portion, for example.

According to an embodiment of the MEMS microphone of the present invention, the second flexible portion is, for example, in a net or bar shape.

According to an embodiment of the MEMS microphone of the present invention, the MEMS microphone further comprises a second dielectric layer at least partially disposed between the second electrode and the substrate.

The present invention further provides an MEMS microphone, having a first electrode, a second electrode and a first dielectric layer. The first electrode is disposed on a substrate. The first electrode has a first flexible portion. The second electrode is disposed between the first electrode and the substrate. The second electrode is a first multi-layer structure. The first dielectric layer is partially disposed between the first electrode and the second electrode so as to suspend the first flexible portion.

According to an embodiment of the MEMS microphone of the present invention, a material of the first multi-layer structure is, for example, polysilicon/polycide or polysilicon/polycide/titanium/titanium nitride/tungsten/aluminum.

According to an embodiment of the MEMS microphone of the present invention, the first electrode is, for example, a second multi-layer structure, and a material of the second multi-layer structure includes polysilicon/polycide, aluminum/copper, titanium/aluminum, titanium nitride/titanium/aluminum-copper alloy/titanium nitride/titanium, titanium nitride/aluminum-copper alloy/titanium nitride, titanium nitride/titanium/titanium nitride or titanium nitride/titanium.

The manufacturing process of the MEMS microphone of the present invention is capable of integrating a manufacturing process of complementary metal-oxide semiconductor (CMOS) or non-volatile memory so as to reduce manufacturing steps and simplify manufacturing process. Thus, the electrodes of the MEMS microphone have features of good extension capability, low resistance, high sensitivity and etching-resistant capability.

In order to make the above and other objects, features, and advantages of the present invention more comprehensible, an embodiment accompanied with a figure is described in detail below.

### BRIEF DESCRIPTION OF THE DRAWINGS

FIG. 1A illustrates a cross-sectional view of a microelectromechanical system microphone (MEMS microphone) according to an embodiment of the present invention.

FIG. 1B illustrates a top view of an upper electrode in FIG. 1A.

FIG. 2A illustrates a cross-sectional view of an MEMS microphone according to another embodiment of the present invention.

FIG. 2B illustrates a top view of an upper electrode and a lower electrode in FIG. 2A.

FIG. 3 illustrates a cross-sectional view of an MEMS microphone according to yet another embodiment of this invention.

FIG. 4 illustrates a cross-sectional view of an MEMS microphone according to yet another embodiment of this invention.

FIG. 5 illustrates a cross-sectional view of an MEMS microphone according to yet another embodiment of this invention.

### DESCRIPTION OF EMBODIMENTS

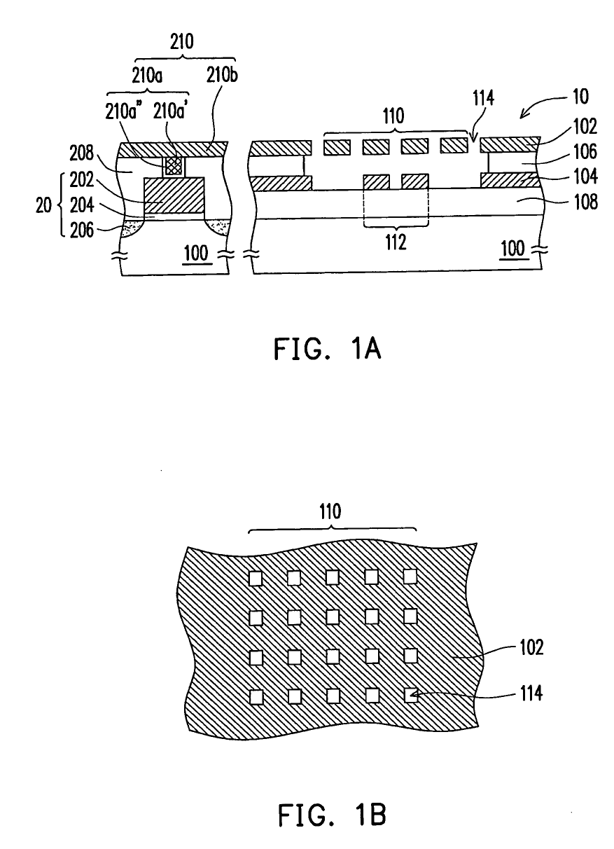

FIG. 1A illustrates a cross-sectional view of a microelectromechanical system microphone (MEMS microphone) according to an embodiment of this invention. The manufacturing process of the MEMS microphone of the present invention is capable of integrating a manufacturing process of complementary metal-oxide semiconductor (CMOS) so as to simplify manufacturing steps. Thus, the present invention will be described according to the following embodiments, wherein both the CMOS and MEMS microphone are disposed on a substrate.

Referring to FIG. 1A, an MEMS microphone 10 and a CMOS 20 are disposed on different areas of a substrate 100 respectively. The CMOS 20 includes a gate 202 disposed on the substrate 100, a gate dielectric layer 204 disposed between the gate 202 and the substrate 100, and a doped region 206 in the substrate 100 disposed on both sides of the gate 202. In addition, a dielectric layer 208 is disposed on the substrate 100 and covered by the CMOS 20. The dielectric layer 208 has an interconnect 210 therein. The interconnect 210 is consisted of plug 210a and wire 210b. The plug 210a includes a metal layer 210′ and a barrier layer 210a″. A material of the metal layer 210′ is, for example, tungsten or aluminum. A material of the barrier layer 210a″ is, for example, titanium/titanium nitride or tantalum/tantalum nitride. A material of the wire 210b is, for example, titanium nitride/aluminum-copper alloy/titanium nitride or tantalum nitride/copper/tantalum nitride, wherein titanium nitride and tantalum nitride are barrier materials. In addition, in the other embodiment, the plug and the wire may be formed by a dual damascene process, and a material of the plug and the wire may be metal (ex. Cu) or alloy. In the present embodiment, the interconnect 210 may be electrically connected with the gate 202. In the other embodiment, the interconnect 210 may be electrically connected with the doped region 206.

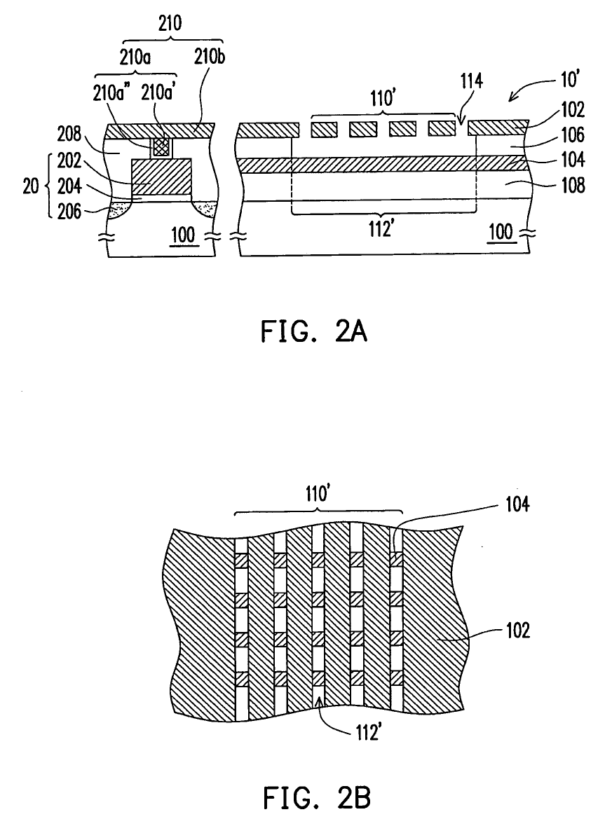

The MEMS microphone 10 includes a first electrode 102, a second electrode 104, a dielectric layer 106 and a dielectric layer 108. The first electrode 102 is disposed on the substrate 100 and has a flexible portion 110. The second electrode 104 is disposed between the first electrode 102 and the substrate 100. In the present embodiment, the second electrode 104 has a flexible portion 112. In the other embodiment, the second electrode 104 may not have the flexible portion. The flexible portion 110 at least partially overlaps the flexible portion 112. The flexible portions 110 and 112 are, for example, in a net or bar shape. In the present embodiment, the flexible portions 110 and 112 are in a net shape. That is, the flexible portion 110 in the first electrode 102 and the flexible portion 112 in the second electrode 104 respectively have a plurality of meshes 114, as shown in FIG. 1B. In another embodiment, as shown in FIGS. 2A and 2B, flexible portions 110′ and 112′ of an MEMS microphone 10′ are, for example, in an interlaced bar-shaped structure. Certainly, in other embodiments (not shown), the second electrode 104 may be a single-film structure.

Furthermore, the dielectric layer 106 is partially disposed between the first electrode 102 and the second electrode 104 so as to suspend the flexible portion 110 of the first electrode 102. The dielectric layer 108 is at least partially disposed between the second electrode 104 and the substrate 100. In the other embodiment, the dielectric layer 108 may be omitted according to actual requirement. In the present embodiment, the dielectric layer 108 is disposed between the second electrode 104 and the substrate 100. Apparently, in other embodiments (not shown), the dielectric layer 108 may be partially disposed between the second electrode 104 and the substrate 100 so as to suspend the flexible portion 112 of the second electrode 104, similarly as the dielectric layer 106.

The manufacturing process of the MEMS microphone of the present invention is capable of integrating a CMOS manufacturing process. Thus, the material of each layer in the MEMS microphone is corresponding to the material of each layer in the CMOS.

In detail, a method for forming the gate 202 is generally to form a polysilicon layer and then perform a patterning process. Thus, during the manufacturing process of the gate 202, a polysilicon layer may be formed in an area where the CMOS is to be formed and in an area where the MEMS microphone is to be formed simultaneously. Then the polysilicon layers of both the two areas are patterned by the patterning process so as to form the gate 202 and the second electrode 104, respectively. Certainly, according to actual requirement, the polysilicon layer may be substituted as a polycide layer or the combination of the polysilicon layer and the polycide layer. That is, a material of the second electrode 104 in the MEMS microphone 10 is polysilicon, polycide or the combination thereof.

In addition, during the gate dielectric layer 204 is formed, the dielectric layer 108 may be formed simultaneously.

In the other embodiment, the manufacture of the first electrode 102 can be integrated with that of the wire 210b so that the material of the first electrode 102 is identical to that of the wire 210b.

In the other embodiment, the manufacture of the second electrode 104 can be integrated with that of the gate 202 and that of the wire 210b so that the material of the second electrode 104 is, for example, polysilicon/polycide/titanium/titanium nitride/tungsten/aluminum.

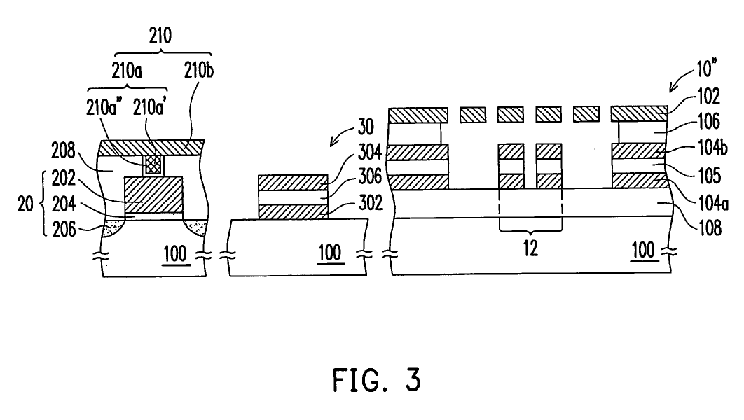

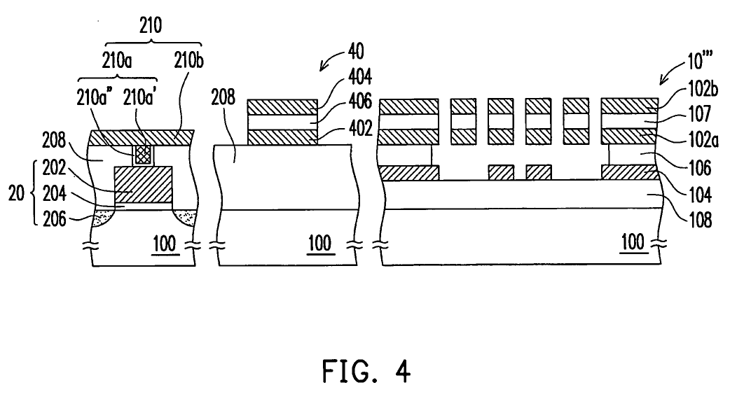

In addition, the manufacturing process of the MEMS microphone of the present invention may be capable of integrating a manufacturing process of the CMOS and a manufacturing process of polysilicon-insulator-polysilicon (PIP) capacitor as shown in FIG. 3 or metal-insulator-metal (MIM) capacitor as shown in FIG. 4.

Referring to FIG. 3, during manufacturing the gate 202, a lower electrode 302 of the PIP capacitor and a first portion 104a of the second electrode of the MEMS microphone 10″ are formed simultaneously. During manufacturing a capacitor dielectric layer 306, a dielectric layer 105 is formed simultaneously. During manufacturing an upper electrode 304 of the PIP capacitor, a second portion 104b of the second electrode of the MEMS microphone 10″ is formed simultaneously. Therefore, the material of the first portion 104a and the second portion 104b is the same with that of the lower electrode 302 and the upper electrode 304, respectively, such as polysilicon, polycide or the combination thereof. In the present embodiment, the first portion 104a is aligned with the second portion 104b. In the other embodiment, the first portion 104a and the second portion 104b are interlaced.

Referring to FIG. 4, during manufacturing the gate 202, the second electrode 104 of the MEMS microphone 10′″ id formed simultaneously. During manufacturing a lower 402 of the MIM capacitor 40, a first portion 102a of the first electrode of the MEMS microphone 10′″ is formed simultaneously. During manufacturing a capacitor dielectric layer 406, a dielectric layer 107is formed simultaneously. During manufacturing an upper 404 of the MIM capacitor 40, a second portion 102b of the first electrode of the MEMS microphone 10′″ is formed simultaneously. Therefore, the material of the first portion 102a and the second portion 102b are the same with that of the lower electrode 402 and the upper electrode 404, respectively, such as aluminum/copper, titanium/aluminum, titanium nitride/titanium/aluminum-copper alloy/titanium nitride/titanium, titanium nitride/aluminum-copper alloy/titanium nitride, titanium nitride/titanium/titanium nitride or titanium nitride/titanium. In the other embodiment, the second electrode of the MEMS microphone 10′″ may be formed simultaneously during manufacturing the lower electrode 402 or the upper electrode 404 only. In addition, in another embodiment, the first portion 102a and the second portion 102b are stacked to formed the second electrode of the MEMS microphone 10′″ without manufacturing the dielectric layer 107.

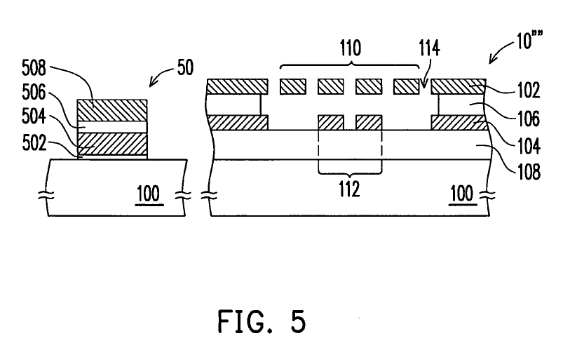

Furthermore, the manufacturing process of the MEMS microphone of the present invention may be capable of integrating a manufacturing process of non-volatile memory as shown in FIG. 5. Referring to FIG. 5, a non-volatile memory 50 includes a tunneling dielectric layer 502, a floating gate 504, an inter-gate dielectric layer 506 and a control gate 508 stacked on the substrate 100. During manufacturing the floating gate 504, the second electrode 104 of the MEMS microphone 10″″ is formed simultaneously. During manufacturing the control gate 508, the first electrode 102 of the MEMS microphone 10″″ is formed simultaneously. Therefore, the material of the first electrode 102 and the second electrode 104 are the same with that of the control gate 508 and the floating gate 504, respectively, such as polysilicon, polycide or polysilicon/polycide.

As described, the first electrode and the second electrode in the MEMS microphone are made of one of the aforementioned materials, and thus, the first electrode and the second electrode have features of good extension capability, low resistance, high sensitivity and etching-resistant capability. Particularly, during the process of manufacturing the MEMS microphone, it is general to perform an etching process after the first electrode is formed to remove the dielectric layer under the flexible portion so as to suspend the flexible portion. Hence, the material of titanium nitride/titanium provides the first electrode with better etching-resistant capability during the etching process, wherein the thickness of the titanium nitride layer is preferably 1000 Å, and the thickness of the titanium layer is preferably 100 Å.

In view of the foregoing, the present invention integrates the manufacturing process of MEMS microphone and that of CMOS or non-volatile memory so as to achieve simplifying manufacturing process, and thus the electrodes of the MEMS can have features of good extension capability, low resistance, high sensitivity and etching-resistant capability.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A mircroelectromechnical system microphone, comprising:
a first electrode, disposed on a substrate and having a first flexible portion;
a second electrode, disposed between the first electrode and the substrate, and a material of the second electrode comprising polysilicon or polycide; and
a first dielectric layer, partially disposed between the first electrode and the second electrode so as to suspend the first flexible portion.

2. The mircroelectromechnical system microphone according to claim 1, wherein a material of the first electrode comprises polysilicon, polycide, metal or alloy.

3. The mircroelectromechnical system microphone according to claim 1, wherein the first electrode is a multi-layer structure, and a material of the multi-layer structure comprises polysilicon/polycide, aluminum/copper, titanium/aluminum, titanium nitride/titanium/aluminum-copper alloy/titanium nitride/titanium, titanium nitride/aluminum-copper alloy/titanium nitride, titanium nitride/titanium/titanium nitride or titanium nitride/titanium.

4. The mircroelectromechnical system microphone according to claim 1, wherein the first flexible portion is in a net shape or a bar shape.

5. The mircroelectromechnical system microphone according to claim 1, wherein the second electrode has a second flexible portion, and the first flexible portion at least partially overlaps the second flexible portion.

6. The mircroelectromechnical system microphone according to claim 1, wherein the second flexible portion is in a net shape or a bar shape.

7. The mircroelectromechnical system microphone according to claim 1, further comprising a second dielectric layer at least partially disposed between the second electrode and the substrate.

8. A mircroelectromechnical system microphone, comprising:
a first electrode, disposed on a substrate and having a flexible portion;
a second electrode, disposed between the first electrode and the substrate, and the second electrode is a first multi-layer structure; and
a first dielectric layer, partially disposed between the first electrode and the second electrode so as to suspend the first flexible portion.

9. The mircroelectromechnical system microphone according to claim 8, wherein a material of the first multi-layer structure comprises polysilicon/polycide or polysilicon/polycide/titanium/titanium nitride/tungsten/aluminum.

10. The mircroelectromechnical system microphone according to claim 8, wherein a material of the first electrode comprises polysilicon, polycide, metal or alloy.

11. The mircroelectromechnical system microphone according to claim 8, wherein the first electrode is a second multi-layer structure, wherein a material of the second multi-layer structure comprises polysilicon/polycide, aluminum/copper, titanium/aluminum, titanium nitride/titanium/aluminum-copper alloy/titanium nitride/titanium, titanium nitride/aluminum-copper alloy/titanium nitride, titanium nitride/titanium/titanium nitride or titanium nitride/titanium.

12. The mircroelectromechnical system microphone according to claim 8, wherein the first flexible portion is in a net shape or a bar shape.

13. The mircroelectromechnical system microphone according to claim 8, wherein the second electrode has a second flexible portion, and the first flexible portion at least partially overlaps the second flexible portion.

14. The mircroelectromechnical system microphone according to claim 8, wherein the second flexible portion is in a net shape or a bar shape.

15. The mircroelectromechnical system microphone according to claim 8, further comprising a second dielectric layer at least partially disposed between the second electrode and the substrate.
